(19) United States
(12) Patent Application Publication
(10) Pub. No.: US 2025/0254545 A1
(43) Pub. Date: Aug. 7, 2025

(54) MOBILE TERMINAL TEST APPARATUS AND CALL CONNECTION CONFIRMATION METHOD THEREFOR

(71) Applicant: ANRITSU CORPORATION, Kanagawa (JP)

(72) Inventor: Takahiro HOSOYA, Kanagawa (JP)

(21) Appl. No.: 19/005,503

(22) Filed: Dec. 30, 2024

(30) Foreign Application Priority Data
Feb. 6, 2024 (JP) 2024-016519

(51) Int. Cl. H04W 24/06; H04W 8/22; H04W 16/18

(52) U.S. Cl. CPC H04W 24/06; H04W 8/22; H04W 16/18

(57) ABSTRACT

To provide a mobile terminal test apparatus capable of confirming whether call connection is possible by using setting of a test apparatus before the call connection and improving efficiency of a test. A control unit 6 that acquires UE Capability Information through communication with a mobile terminal 10, collates whether a Band Combination set in the own apparatus is present in a Carrier Aggregation Band Combination List included in the UE Capability Information, and displays, on a display unit 5, that call connection is possible, in a case where the Band Combination set in the mobile terminal test apparatus is present in the Carrier Aggregation Band Combination List is provided.

### TECHNICAL FIELD

The present invention relates to a mobile terminal test apparatus that tests a mobile terminal.

### BACKGROUND ART

In a case where a mobile terminal such as a portable phone or a data communication terminal is developed, it is necessary to test whether or not the developed mobile terminal can normally perform communication. Therefore, a test in which a mobile terminal to be tested is connected to a test apparatus that operates as a simulated base station that simulates the functions of an actual base station, communication is performed between the test apparatus and the mobile terminal, and the content of the communication is confirmed is performed.

In addition, the 3rd generation partnership project (3GPP), in which standards of radio communication are created, has introduced a carrier aggregation technology in the standard of long term evolution-advanced (LTE-A). This carrier aggregation aims to improve a transmission speed by performing communication using a plurality of LTE carriers at the same time.

In the carrier aggregation, communication is performed by using a plurality of LTE carriers called component carriers (hereinafter, also referred to as CCs). In the carrier aggregation, communication is performed with one primary component carrier (hereinafter, also referred to as a PCC), which is a CC necessary for a mobile terminal to maintain the connection with a base station, and one or more secondary component carriers (hereinafter, also referred to as SCCs), which is a CC used for improving the transmission speed between the mobile terminal and the base station.

In the carrier aggregation, a combination of frequency bands for performing the carrier aggregation is defined as a Band Combination. In addition, in the mobile terminal that performs the carrier aggregation, a combination of the frequency bands that can be supported is determined and set.

Patent Document 1 discloses that a Band Combination supported by a mobile terminal is acquired based on UE Capability Information received from the mobile terminal.

### RELATED ART DOCUMENT

### Patent Document

[Patent Document 1] JP-A-2020-137047

### DISCLOSURE OF THE INVENTION

### Problem that the Invention is to Solve

In a case where the carrier aggregation is tested, a test apparatus needs to be set according to a combination of frequency bands supported by the mobile terminal.

In principle, a mobile terminal can perform a call connection only in the Band Combination notified by the UE Capability Information. Therefore, in a case where the value of the Band Combination notified by the UE Capability Information is different from the setting of the test apparatus, the call connection cannot be made, and the efficiency of the test is deteriorated.

Thus, an object of the present invention is to provide a mobile terminal test apparatus capable of confirming whether call connection is possible by using setting of a test apparatus before the call connection and improving efficiency of a test.

### Means for Solving the Problem

A mobile terminal test apparatus according to the present invention is a mobile terminal test apparatus 1 that tests a mobile terminal 10 by simulating a base station of mobile communication, the mobile terminal test apparatus including: a control unit 6 that acquires UE Capability Information through communication with the mobile terminal, collates whether a Band Combination set in the mobile terminal test apparatus is present in a Carrier Aggregation Band Combination List included in the UE Capability Information, and displays, on a display unit 5, that call connection is possible, in a case where the Band Combination set in the mobile terminal test apparatus is present in the Carrier Aggregation Band Combination List.

With this configuration, it is collated whether the Band Combination set in the mobile terminal test apparatus is present in the Carrier Aggregation Band Combination List included in the UE Capability Information, and, in a case where the Band Combination set in the mobile terminal test apparatus is present in the Carrier Aggregation Band Combination List, it is displayed that the call connection is possible. Therefore, it is possible to confirm whether the call connection is possible by setting of the test apparatus before the call connection, and it is possible to improve the efficiency of the test.

Further, in the mobile terminal test apparatus of the present invention, the control unit displays that the call connection is possible by changing a display of a header portion corresponding to each component carrier (CC).

With this configuration, it is displayed that the call connection is possible, by changing the display of the header portion corresponding to each CC. Therefore, it is possible to confirm whether the call connection is possible by setting of the test apparatus before the call connection, and it is possible to improve the efficiency of the test.

Further, in the mobile terminal test apparatus of the present invention, each time setting of a parameter is changed, the control unit collates whether the Band Combination set in the mobile terminal test apparatus is present in the Carrier Aggregation Band Combination List and displays whether the call connection is possible.

With this configuration, it is collated whether the Band Combination set in the mobile terminal test apparatus is present in the Carrier Aggregation Band Combination List each time setting of a parameter is changed, and it is displayed whether the call connection is possible. Therefore, it is possible to know whether the call connection is possible each time the setting of the parameter is changed, and it is possible to improve the efficiency of the test.

Further, a call connection confirmation method of the present invention is a call connection confirmation method of a mobile terminal test apparatus 1 that tests a mobile terminal 10 by simulating a base station of mobile communication, the call connection confirmation method including: a step of acquiring UE Capability Information through communication with the mobile terminal; a step of collating whether or not a Band Combination set in the mobile terminal test apparatus is present in a Carrier Aggregation Band Combination List included in the UE Capability Information; and a step of displaying that call connection is possible, in a case where the Band Combination set in the mobile terminal test apparatus is present in the Carrier Aggregation Band Combination List.

In the call connection confirmation method of the present invention, in the step of displaying, it is displayed that the call connection is possible, by changing a display of a header portion corresponding to each component carrier (CC).

In the call connection confirmation method of the present invention, in the step of collating, each time setting of a parameter is changed, it is collated whether the Band Combination set in the mobile terminal test apparatus is present in the Carrier Aggregation Band Combination List.

With this configuration, it is collated whether the Band Combination set in the mobile terminal test apparatus is present in the Carrier Aggregation Band Combination List included in the UE Capability Information, and, in a case where the Band Combination set in the mobile terminal test apparatus is present in the Carrier Aggregation Band Combination List, it is displayed that the call connection is possible. Therefore, it is possible to confirm whether the call connection is possible by setting of the test apparatus before the call connection, and it is possible to improve the efficiency of the test.

### Advantage of the Invention

The present invention can provide a mobile terminal test apparatus capable of improving efficiency of a test.

### BRIEF DESCRIPTION OF THE DRAWINGS

FIG. 1 is a block diagram illustrating a mobile terminal test apparatus according to an embodiment of the present invention.

FIG. 2 is a diagram illustrating an example of a call connection confirmation screen of the mobile terminal test apparatus according to the embodiment of the present invention.

FIG. 3 is a flowchart describing a procedure of a call connection confirmation process of the mobile terminal test apparatus according to the embodiment of the present invention.

### BEST MODE FOR CARRYING OUT THE INVENTION

Hereinafter, a mobile terminal test apparatus according to an embodiment of the present invention will be described in detail with reference to the drawings.

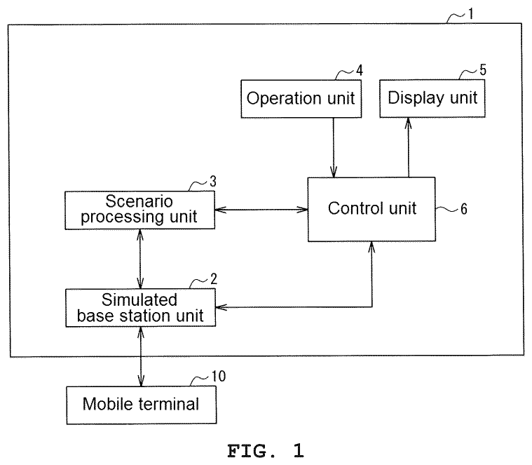

In FIG. 1, a mobile terminal test apparatus 1 according to the embodiment of the present invention is configured to transmit and receive RF signals to and from a mobile terminal 10 in a wired manner via a coaxial cable or the like, as a simulated base station. The mobile terminal test apparatus 1 may wirelessly transmit and receive an RF signal to and from the mobile terminal 10 via an antenna.

The mobile terminal test apparatus 1 is configured to include a simulated base station unit 2, a scenario processing unit 3, an operation unit 4, a display unit 5, and a control unit 6.

The simulated base station unit 2 transmits and receives an RF signal to and from the mobile terminal 10 under the control of the scenario processing unit 3. The simulated base station unit 2 outputs the state of the communication with the mobile terminal 10 and the like to the control unit 6.

In response to an instruction from the control unit 6, the scenario processing unit 3 reads out a stored scenario and causes the simulated base station unit 2 to transmit notification information or execute a communication sequence with the mobile terminal 10, based on the scenario.

The operation unit 4 is configured by an input device such as a keyboard, a mouse, and a touch panel, and outputs information and the like that are input by an operation and are required for generating the scenario, to the control unit 6. The display unit 5 is configured by an image display device such as a liquid crystal display, and displays an image for inputting information required for generating a scenario, an image indicating a state during a test, and the like.

In accordance with an instruction input to the operation unit 4, the control unit 6 causes the display unit 5 to display a test scenario creation screen to input information required for generating the test scenario, or to generate the test scenario based on the information input to the operation unit 4 on the test scenario creation screen. In addition, in accordance with an instruction input to the operation unit 4, the control unit 6 transmits the instruction to the scenario processing unit 3 to perform a test based on a test scenario stored in a storage device or to display the state or the like during the test on the display unit 5 based on information on the state of each layer and the state of communication with the mobile terminal 10, which are transmitted from the scenario processing unit 3, and the like.

Here, the mobile terminal test apparatus 1 is configured by a computer device (not illustrated) provided with a communication module for communicating with the mobile terminal 10. The computer device includes a central processing unit (CPU), a read only memory (ROM), a random access memory (RAM), a storage device such as a hard disk device, an input and output port, and a touch panel (not illustrated).

A program for causing the computer device to function as the mobile terminal test apparatus 1 is stored in the ROM and the hard disk device of the computer device. That is, the computer device functions as the mobile terminal test apparatus 1 by the CPU executing the program stored in the ROM by using the RAM as a work area.

As described above, in the present embodiment, the scenario processing unit 3 and the control unit 6 are configured by the CPU, and the simulated base station unit 2 is configured by the communication module.

In the mobile terminal test apparatus 1 having such a configuration, in a case where a test on the mobile terminal 10 is executed, first, a scenario for use in the test is created by a user. In a case where a scenario creation function is selected by an operation of a user on the operation unit 4, for example, the control unit 6 displays the scenario creation screen on the display unit 5 to cause a setting of information of a base station simulated by the simulated base station unit 2, a sequence intended to be executed, and the like.

The user sets various types of information as the base station according to the desired test. The control unit 6 generates notification information, sequence information, and the like based on the set information, and stores the notification information, the sequence information, and the like in association with identification information as the scenario of the simulated base station.

In a case where the carrier aggregation is tested, the scenario needs to be set according to a combination of frequency bands supported by the mobile terminal 10. In the mobile terminal test apparatus 1 of the present embodiment, it is collated whether the same Band Combination as the band set in the mobile terminal test apparatus 1 is present in a Carrier Aggregation Band Combination List of UE Capability Information that can be acquired from the mobile terminal 10, and in a case where the same Band Combination as the setting is present, it is displayed on the display unit 5 that the call connection is possible.

When it is collated whether a Band set in the mobile terminal test apparatus 1 is included in the Band Combination supported by the mobile terminal 10, based on information on the UE Capability Information from the mobile terminal 10, the user connects the mobile terminal test apparatus 1 and the mobile terminal 10 in a wired manner, and turns on the power of the mobile terminal 10 to perform position registration.

When the scenario processing unit 3 receives the UE Capability Information from the mobile terminal 10 in the sequence of the position registration, the scenario processing unit 3 transmits the content thereof to the control unit 6. The present invention is not limited to the information at the time of the position registration, and the scenario processing unit 3 may request the transmission of the UE Capability Information to the mobile terminal 10 in response to a request from the control unit 6 and may transmit the received UE Capability Information to the control unit 6.

When the control unit 6 receives the UE Capability Information from the scenario processing unit 3, the control unit 6 collates whether the Band Combination set in the apparatus is present in the Carrier Aggregation Band Combination List of the UE Capability Information.

In a case where the Band Combination set in the apparatus is present in the Carrier Aggregation Band Combination List, the control unit 6 displays, on the display unit 5, that the call connection is possible.

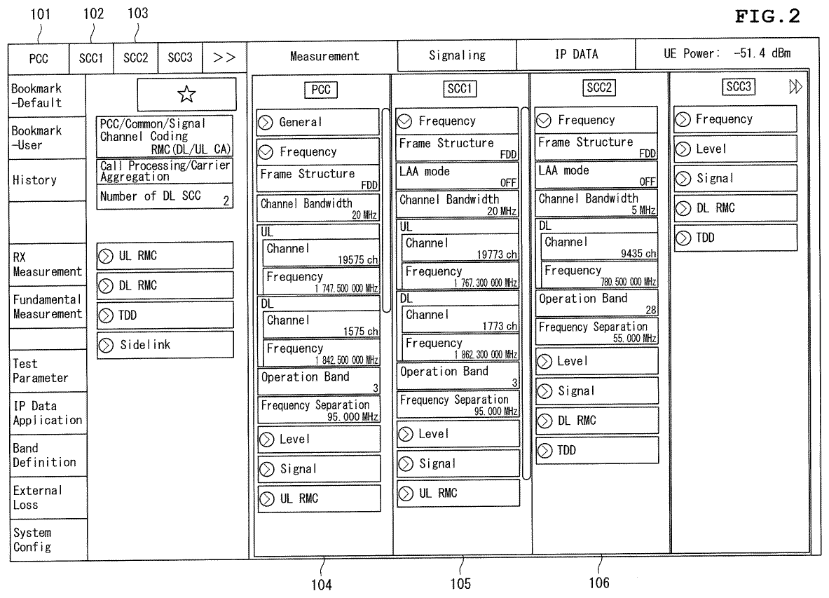

The control unit 6 displays that the call connection is possible by the current setting, for example, on a screen as illustrated in FIG. 2.

In FIG. 2, a PCC tab 101 is a tab for selecting the setting of the CC set as a PCC.

A SCC1 tab 102 is a tab for selecting the setting of the CC set as a first SCC.

A SCC2 tab 103 is a tab for selecting the setting of the CC set as a second SCC.

FIG. 2 illustrates a state in which the PCC, the SCC1, and the SCC2 are set. In the present embodiment, the PCC and the SCC1 to the SCC3 can be set.

A PCC display portion 104 displays the content of the setting parameter of the PCC, and, when a corresponding portion is selected by the operation of the operation unit 4, the control unit 6 receives a change in the value of the corresponding parameter.

A SCC1 display portion 105 displays the content of the setting parameter of the SCC1, and, when a corresponding portion is selected by the operation of the operation unit 4, the control unit 6 receives a change in the value of the corresponding parameter.

A SCC2 display portion 106 displays the content of the setting parameter of the SCC2, and, when a corresponding portion is selected by the operation of the operation unit 4, the control unit 6 receives a change in the value of the corresponding parameter.

In a case where the Band Combination set in the apparatus is present in the Carrier Aggregation Band Combination List, the control unit 6 changes the colors of the PCC tab 101, the SCC1 tab 102, and the SCC2 tab 103 to display that the call connection is possible.

The user can confirm the current setting by the PCC display portion 104, the SCC1 display portion 105, and the SCC2 display portion 106, and in a case where the call connection is not possible, the user can change the setting by selecting a portion intended to be changed in the PCC display portion 104, the SCC1 display portion 105, and the SCC2 display portion 106 by the operation of the operation unit 4.

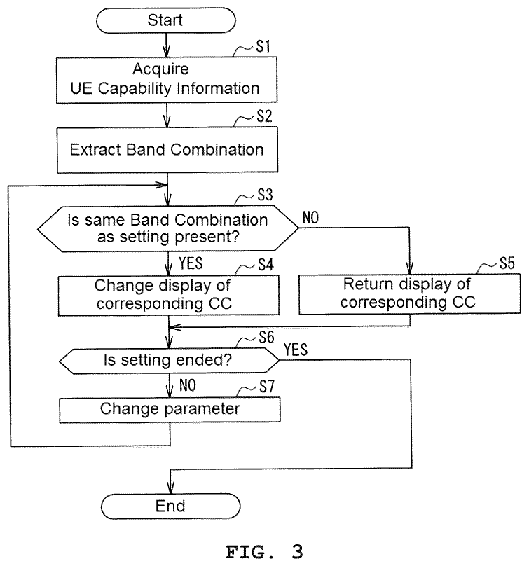

A call connection confirmation process by the mobile terminal test apparatus 1 according to the present embodiment configured as described above will be described with reference to FIG. 3. The call connection confirmation process described below is executed when the execution of the call connection confirmation is selected by the operation of the user on the operation unit 4.

In Step S1, the control unit 6 acquires UE Capability Information from the scenario processing unit 3. After executing the process of Step S1, the control unit 6 executes the process of Step S2.

In Step S2, the control unit 6 extracts the Band Combination from the UE Capability Information. After executing the process of Step S2, the control unit 6 executes the process of Step S3.

In Step S3, the control unit 6 determines whether or not the same Band Combination as the setting of the apparatus is present.

In a case where it is determined that the same Band Combination as the setting of the apparatus is present, the control unit 6 executes the process of Step S4. In a case where it is determined that the same Band Combination as the setting of the apparatus is not present, the control unit 6 executes the process of Step S5.

In Step S4, the control unit 6 changes the display of the CC in which the same Band Combination is present. After executing the process of Step S4, the control unit 6 executes the process of Step S6.

In Step S5, the control unit 6 returns the display of the CC in which the same Band Combination is not present. After executing the process of Step S5, the control unit 6 executes the process of Step S6.

In Step S6, the control unit 6 determines whether or not the end of the setting of the parameter is selected and the setting is ended.

In a case where it is determined that the setting is ended, the control unit 6 ends the call connection confirmation process. In a case where it is determined that the setting is not ended, the control unit 6 executes the process of Step S7.

In Step S7, the control unit 6 performs processing of changing the parameter. After executing the process of Step S7, the control unit 6 executes the process of Step S3.

As described above, in the above-described embodiment, the control unit 6 collates whether the Band Combination set in the apparatus is present in the Carrier Aggregation Band Combination List included in the UE Capability Information, and, in a case where the Band Combination set in the apparatus is present in the Carrier Aggregation Band Combination List, it is displayed on the display unit 5 that the call connection is possible.

As a result, the Band Combination set in the apparatus is present in the Carrier Aggregation Band Combination List, it is displayed that the call connection is possible. Therefore, it is possible to confirm whether the call connection is possible by setting of the test apparatus before the call connection, and it is possible to improve the efficiency of the test.

In addition, the control unit 6 displays that the call connection is possible, by changing the display of the PCC tab 101, the SCC1 tab 102, and the SCC2 tab 103 displayed corresponding to each CC.

As a result, in a case where the call connection is possible, the display of the PCC tab 101, the SCC1 tab 102, and the SCC2 tab 103 displayed corresponding to each CC is changed and displayed. Therefore, it is possible to confirm whether the call connection is possible by setting of the test apparatus before the call connection, and it is possible to improve the efficiency of the test.

In addition, each time setting of a parameter is changed, the control unit 6 collates whether the Band Combination set in the apparatus is present in the Carrier Aggregation Band Combination List, and displays whether the call connection is possible.

As a result, each time the setting of the parameter is changed, it is collated whether or not the Band Combination set in the apparatus is present in the Carrier Aggregation Band Combination List, and it is displayed whether or not the call connection is possible. Therefore, it is possible to know whether the call connection is possible each time the setting of the parameter is changed, and it is possible to improve the efficiency of the test.

Hitherto, the embodiments of the present invention have been disclosed, but it is clear that changes can be made by those skilled in the art without departing from the scope of the present invention. All such modifications and equivalents are intended to be included in the claims as follows.

### DESCRIPTION OF REFERENCE NUMERALS AND SIGNS

1 Mobile Terminal Test Apparatus
3 Scenario Processing Unit
4 Operation Unit
5 Display Unit
6 Control Unit
10 Mobile Terminal
101 PCC Tab
102 SCC1 Tab
103 SCC2 Tab
104 PCC Display Portion
105 SCC1 Display Portion
106 SCC2 Display Portion

What is claimed is:

1. A mobile terminal test apparatus that tests a mobile terminal by simulating a base station of mobile communication, the mobile terminal test apparatus comprising:
a control unit that acquires UE Capability Information through communication with the mobile terminal, collates whether a Band Combination set in the mobile terminal test apparatus is present in a Carrier Aggregation Band Combination List included in the UE Capability Information, and displays, on a display unit, that call connection is possible, in a case where the Band Combination set in the mobile terminal test apparatus is present in the Carrier Aggregation Band Combination List.

2. The mobile terminal test apparatus according to claim 1, wherein
the control unit displays that the call connection is possible by changing a display of a header portion corresponding to each component carrier (CC).

3. The mobile terminal test apparatus according to claim 1, wherein
each time setting of a parameter is changed, the control unit collates whether the Band Combination set in the mobile terminal test apparatus is present in the Carrier Aggregation Band Combination List, and displays whether the call connection is possible.

4. A call connection confirmation method of a mobile terminal test apparatus that tests a mobile terminal by simulating a base station of mobile communication, the call connection confirmation method comprising:
a step of acquiring UE Capability Information through communication with the mobile terminal;
a step of collating whether a Band Combination set in the mobile terminal test apparatus is present in a Carrier Aggregation Band Combination List included in the UE Capability Information; and
a step of displaying that call connection is possible, in a case where the Band Combination set in the mobile terminal test apparatus is present in the Carrier Aggregation Band Combination List.

5. The call connection confirmation method according to claim 4, wherein
in the step of displaying, it is displayed that the call connection is possible, by changing a display of a header portion corresponding to each CC.

6. The call connection confirmation method according to claim 4, wherein
in the step of collating, each time setting of a parameter is changed, it is collated whether the Band Combination set in the mobile terminal test apparatus is present in the Carrier Aggregation Band Combination List.
